(19) United States
(12) Patent Application Publication
(10) Pub. No.: US 2009/0176538 A1
(43) Pub. Date: Jul. 9, 2009

(54) Two-Way Communication Device with Detachable Boom

(75) Inventors: William Frank Dunn, Austin, TX (US); Andrew J. Haapapuro, Arlington Heights, IL (US); Viorel Drambarean, Skokie, IL (US); Mead C. Killion, Elk Grove Village, IL (US)

Correspondence Address: MCANDREWS HELD & MALLOY, LTD, 500 WEST MADISON STREET, SUITE 3400, CHICAGO, IL, 60661, US

(73) Assignee: ETYMOTIC RESEARCH, INC., Elk Grove Village, IL (US)

(21) Appl. No.: 12/348,954

(22) Filed: Jan. 6, 2009

Related U.S. Application Data
(60) Provisional application No. 61/019,521, filed on Jan. 7, 2008.

(51) Int. Cl. H04M 1/00

(52) U.S. Cl. 455/569.1

(57) ABSTRACT

Certain embodiments provide a two-way communication device that includes: a housing; a first microphone disposed on a boom that is removably attached to the housing; and a second microphone mounted with the housing, wherein when the boom is attached to the housing, the first microphone is operational and the second microphone is not operational, and when the boom is not attached to the housing, the second microphone is operational and the first microphone is not operational. Certain embodiments provide, a two-way communication device that includes a charging jack for providing power to a battery mounted with a housing, wherein the charging jack is only accessible when a boom/microphone assembly is not attached to the housing.

### RELATED APPLICATIONS

This application claims priority to U.S. Provisional Application No. 60/019,521 filed Jan. 7, 2008, entitled “TWO-WAY COMMUNICATION DEVICE WITH DETACHABLE BOOM,” which application is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present technology generally relate to two-way voice communication devices for use with voice communication equipment, such as cellular telephones. More particularly, embodiments of the present technology relate to hands-free, two-way communication devices with a removable boom.

Hands-free, two-way communication devices have become popular. Such devices can be used to communicate while jogging, working, and/or engaging in any activity that requires free movement of the hands. Minimizing the size and weight of such devices is desirable and can increase comfort and/or functionality of such devices.

Wired and wireless hands-free, two-way communication devices are known. Wired devices require a cable between the hands-free device and the associated device, which is often a cellular telephone. In such devices, the cable can be a source of annoyance and noise. For example, the weight of the cable and/or a tug at the cable can cause the earphone(s) of the hands-free device to be dislodged from the ear of the user. Further, the cable that typically runs from the earphone to the associated electrical device may be a significant source of noise. Longitudinal forces created when the cable comes in contact with surrounding objects or with the clothing of the user are normally conducted along the cable to the earphone, where they can be audible to the user.

Microphone positioning can also be an issue for hands-free, two-way communication devices. For example, users of devices that have a microphone disposed along a cable that extends from an earphone housing are often seen manually manipulating the microphone to keep it in a usable position. Such manual manipulation defeats the purpose of the hands-free device, and can cause the earphone(s) of the hands-free device to be dislodged from the ear of the user.

Stability of existing hands-free, two-way communication devices can also be an issue. For example, stability problems can be exacerbated by the use of a boom with a microphone disposed at one end. The weight of the boom can cause the earphone(s) of the hands-free device to be dislodged from the ear of the user, and can also cause the earphone(s) of the hands-free device to rotate away from a functional or comfortable position. Two-way communication devices designed to improve stability are available. For example, the following reference, which is incorporated herein by reference in its entirety, discloses an earpiece/microphone combination that is designed to improve stability: U.S. Pat. No. 5,298,692, entitled “Earpiece for insertion in an ear canal, and an earphone, microphone, and earphone/microphone combination comprising the same” issued Mar. 29, 1994.

Some available hands-free, two-way communication devices have poor external sound isolation for the earphone(s) of the device. This can result in deteriorated sound quality and/or a user using the device at unsafe sound levels, which can damage the user's ear(s). Two-way communication devices with improved external sound isolation for the earphone(s) of the device have been used to combat this problem. For example, the following references, which are incorporated herein by reference in their entirety, disclose a Two-Way Voice Communication Device Having External Acoustic Noise Reduction: United States Provisional Patent Application No. 60/439,234, entitled “Two-Way Voice Communication Device Having External Acoustic Noise Reduction”, filed Jan. 9, 2003; and United States Patent Application Publication No. 2004/0165720, entitled “Two-Way Voice Communication Device Having External Acoustic Noise Reduction”, published Aug. 26, 2004.

Ambient noise can also be an issue when transmitting sound via the microphone of a hands-free, two-way communication device. Noise cancelling microphones have been used to combat ambient noise. For example, the following references, which are incorporated herein by reference in their entirety, disclose a noise cancelling microphone: United States Provisional Patent Application Serial No. 60/507,629, entitled “Noise Canceling Microphone With Acoustically Tuned Ports”, filed Sep. 30, 2003; and U.S. Pat. No. 7,162,041, entitled “Noise Canceling Microphone With Acoustically Tuned Ports”, issued Jan. 9, 2007.

In order to cater to needs of hands-free, two-way communication device users, a two-way communication device with improved functionality and adaptability, and minimal size and weight, is needed.

### BRIEF SUMMARY OF THE INVENTION

Certain embodiments of the present technology provide a two-way communication device comprising: a housing; a receiver mounted with the housing for transducing a first electrical signal into sound; an ear tip for insertion into an ear canal of a user, wherein sound from the receiver is delivered through the ear tip to the user; a first microphone for transducing speech of the user into a second electrical signal, wherein the first microphone is disposed on a boom that is detachably connected to the housing; and a second microphone for transducing speech of the user into a third electrical signal, wherein the second microphone is mounted with the housing, wherein when the boom is attached to the housing, the first microphone is operational and the second microphone is not operational, and when the boom is not attached to the housing, the second microphone is operational and the first microphone is not operational.

For example, in certain embodiments, the first microphone is a directional microphone. For example, in certain embodiments, the first microphone rejects at least 20 dB of ambient noise. For example, in certain embodiments, a portion of the boom that attaches to the housing is keyed such that the boom can only be attached to the housing in one orientation. For example, in certain embodiments, the first microphone is an omni-directional microphone. For example, in certain embodiments, the second microphone is a directional microphone or an omni-directional microphone.

For example, in certain embodiments, the two-way communication device also includes: a battery mounted with the housing; and a charging jack mounted with the housing, wherein the battery receives power from the charging jack, and wherein the charging jack is only accessible when the boom is not attached to the housing.

For example, in certain embodiments, the ear tip is removably attached to the housing. For example, in certain embodiments, upon insertion into the ear canal, the ear tip secures the device in an operable position on the head of the user without requiring use of additional attachment to the user. For example, in certain embodiments, upon insertion of the ear tip into the ear canal, the ear canal provides sole support of the device. For example, in certain embodiments, the ear tip is rotatable within the ear canal of the user to permit adjustment of the vertical position of the housing. For example, in certain embodiments, the ear tip is made of resilient material and comprises a plurality of flanges that, upon insertion into the ear canal, compress, thereby securing the device within the ear canal. For example, in certain embodiments, upon insertion into the ear canal, the ear tip provides a reduction of external acoustic noise of at least 15 dB. For example, in certain embodiments, upon insertion into the ear canal, the ear tip provides a reduction of external acoustic noise of at least 30 dB.

For example, in certain embodiments, the boom is a flexible boom that is deformable to allow adjustment of the distance between the microphone and the mouth of the user.

For example, in certain embodiments, the two-way communication device also includes a switch for canceling the electrical signal from the first microphone or the second microphone. For example, in certain embodiments, the two-way communication device also includes a switch supporting at least one of the following operations: pairing, call answer, call end, call send, call hold, transfer to handset, and call redial. For example, in certain embodiments, the two-way communication device also includes a switch that allows the user to control the volume of sound communicated through the ear tip.

For example, in certain embodiments, the two-way communication device also includes a radio frequency receiver for demodulating a first radio frequency signal into the first electrical signal; and a radio frequency transmitter for transmitting a second radio frequency signal, wherein the second radio frequency signal is modulated to carry the second electrical signal or the third electrical signal. For example, in certain embodiments, the radio frequency communication is compliant with the Bluetooth radio frequency communication standard.

For example, in certain embodiments the two-way communication device also includes an ear hook configured to be removably attached to the housing, wherein the ear hook is configured to contact the back of the ear, thereby providing further support of the device when the ear tip is inserted into the ear canal.

Certain embodiments of the present technology provide a two-way communication device comprising: a housing; a receiver mounted with the housing for transducing a first electrical signal into sound; an ear tip for insertion into an ear canal of a user, wherein sound from the receiver is delivered through the ear tip to the user; a first microphone for transducing speech of the user into a second electrical signal, wherein the first microphone is disposed on a boom that is detachably connected to the housing; a battery mounted with the housing; and a charging jack mounted with the housing, wherein the battery receives power from the charging jack, and wherein the charging jack is only accessible when the boom is not attached to the housing. For example, in certain embodiments, the two-way communication device also includes a second microphone for transducing speech of the user into a third electrical signal, wherein the second microphone is mounted with the housing, and wherein when the boom is attached to the housing, the first microphone is operational and the second microphone is not operational, and when the boom is not attached to the housing, the second microphone is operational and the first microphone is not operational.

Certain embodiments of the present technology provide a two-way communication device comprising: a housing; a receiver mounted with the housing for transducing a first electrical signal into sound; an ear tip for insertion into an ear canal of a user, wherein sound from the receiver is delivered through the ear tip to the user; a first microphone for transducing speech of the user into a second electrical signal, wherein the first microphone is disposed on a boom connected to the housing; and a second microphone for transducing speech of the user into a third electrical signal, wherein the second microphone is mounted with the housing, wherein when the device is in use, the first microphone is operational and the second microphone is not operational, and when the device is not in use, the first microphone is not operational and the second microphone is operational to provide ambient noise to the ear canal of the user.

Certain embodiments of the present technology provide a device comprising: a housing; a receiver mounted with the housing for transducing a first electrical signal into sound; and an ear tip for insertion into an ear canal of a user, wherein sound from the receiver is delivered through the ear tip to the user, wherein upon insertion into the ear canal at a first orientation, the ear tip provides a reduction of external acoustic noise of at least 15 dB, and wherein upon insertion into the ear canal at a second orientation, the ear tip provides a reduction of external acoustic noise of less than 15 dB.

### BRIEF DESCRIPTION OF THE DRAWINGS

FIG. 1A illustrates a side view of a two-way voice communication device used in accordance with an embodiment of the present technology.

FIG. 1B illustrates a perspective view of the two-way voice communication device shown in FIG. 1A.

FIG. 2 illustrates a perspective view of a two-way voice communication device used in accordance with an embodiment of the present technology.

FIG. 3 illustrates a partially sectioned side view of a two-way voice communication device used in accordance with an embodiment of the present technology.

FIG. 4 illustrates a perspective view of an earworn assembly used in accordance with an embodiment of the present technology.

FIG. 5 illustrates a side view of a two-way voice communication device with an earworn assembly without a housing and an ear tip used in accordance with an embodiment of the present technology.

FIG. 6A illustrates a perspective view of a boom/microphone assembly used in accordance with an embodiment of the present technology.

FIG. 6B illustrates a partially sectioned perspective view of a boom/microphone assembly used in accordance with an embodiment of the present technology.

FIG. 7 illustrates a perspective view of a two-way voice communication device used in accordance with an embodiment of the present technology.

FIG. 8A illustrates a schematic of components used to provide electromagnetic compatibility protection for a two-way communication device used in accordance with an embodiment of the present technology.

FIG. 8B illustrates a cross-section of components used to provide electromagnetic compatibility protection for a two-way communication device used in accordance with an embodiment of the present technology.

FIG. 8C illustrates a partial side-view of a boom/microphone assembly that includes an ultrasonic interference protection device used in accordance with an embodiment of the present technology.

FIG. 9A illustrates a battery charging connection and an earworn assembly used in accordance with an embodiment of the present technology.

FIG. 9B illustrates a battery charging connection and an earworn assembly used in accordance with an embodiment of the present technology.

FIG. 9C illustrates a battery charging connection and an earworn assembly used in accordance with an embodiment of the present technology.

FIG. 10 illustrates a two-way voice communication device used in accordance with an embodiment of the present technology that is positioned on the head of a user.

FIG. 11 illustrates estimated noise reduction in dB of a directional microphone disposed on a boom/microphone assembly relative to noise reduction of a microphone mounted with an earworn assembly as a function of frequency in Hz.

FIG. 12 illustrates estimated noise reduction in dB of a directional microphone disposed on a boom/microphone assembly with a port spacing diameter of 1.0 cm.

FIG. 13 illustrates an estimated equivalent frequency-independent noise reduction (SNR gain) for speech, estimated from the Count-The-Dot Articulation Index.

FIG. 14 illustrates testing equipment.

FIG. 15 illustrates results from tests conducted using the testing equipment illustrated in FIG. 14.

FIG. 16 illustrates testing equipment.

FIG. 17 illustrates results from tests conducted using the testing equipment illustrated in FIG. 16.

FIG. 18 illustrates results from tests conducted using the testing equipment illustrated in FIG. 16.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

In this detailed description of certain embodiments and in the Figures, like elements are identified with like numerals.

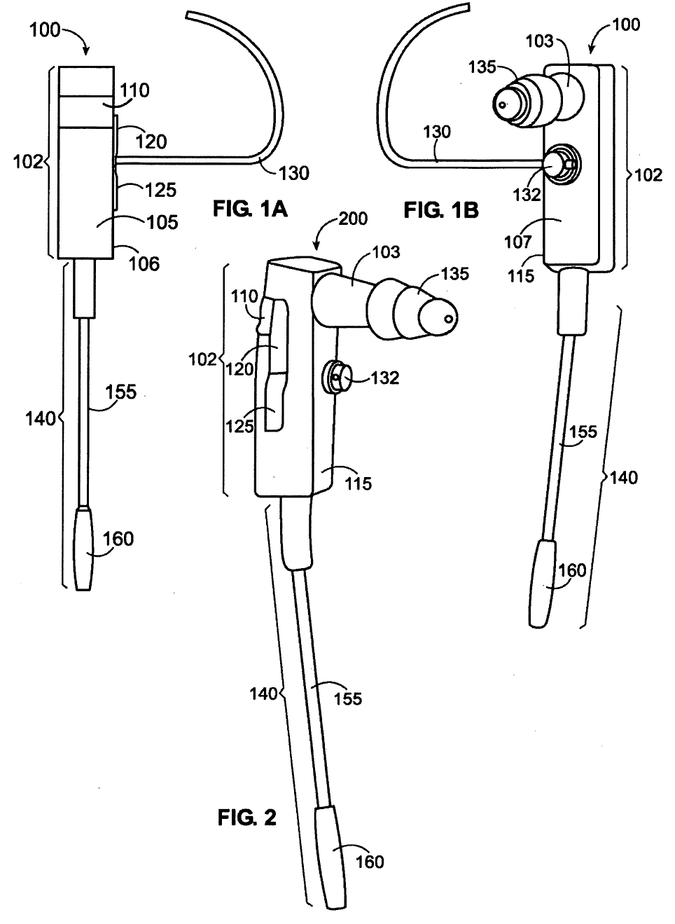

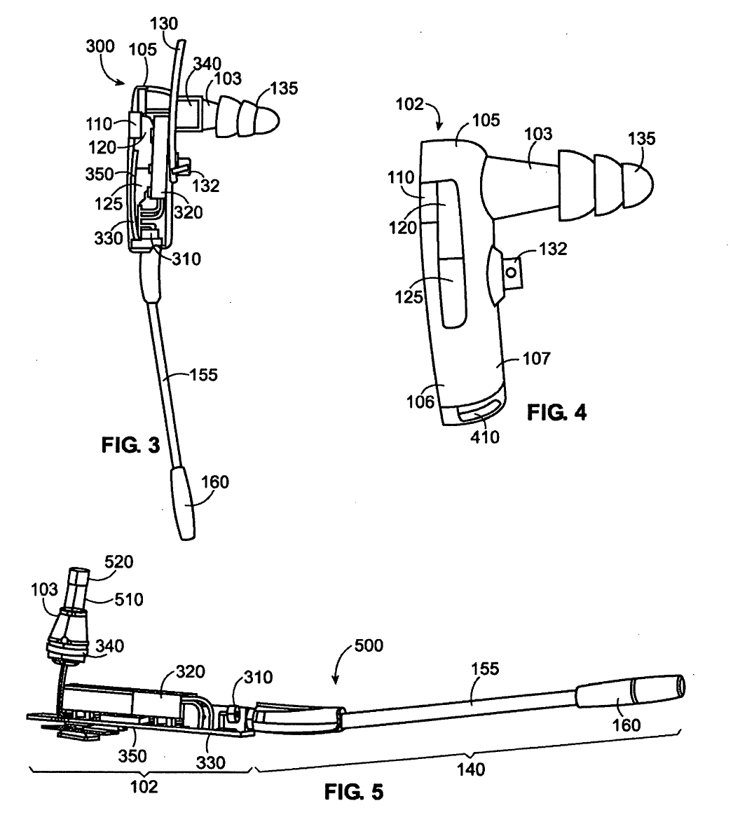

FIG. 1A illustrates a side view of a two-way voice communication device 100 used in accordance with an embodiment of the present technology. FIG. 1B illustrates a perspective view of the two-way voice communication device 100. The device 100 includes an earworn assembly 102 and boom/microphone assembly 140. The earworn assembly 102 includes a jack 410 (shown in FIG. 4) for receiving the boom/microphone assembly 140. The earworn assembly 102 includes a microphone 310 (shown in FIG. 3) and the boom/microphone assembly 140 also includes a microphone 610 (shown in FIG. 6B). When the boom/microphone assembly 140 is attached to the jack 410 of the earworn assembly 102, the microphone 610 of the boom/microphone assembly 140 is operational and the microphone 310 of the earworn assembly 102 is not operational. On the other hand, when the boom/microphone assembly 140 is not attached to the jack 410 of the earworn assembly 102, the microphone 310 of the earworn assembly 102 is operational. To achieve automatic microphone selection, sensing circuitry and microprocessor logic can be used to detect whether the boom/microphone assembly 140 is attached to the jack 410 of the earworn assembly 102, and then select the microphone input accordingly. In such embodiments, the device 100 can automatically adjust amplification characteristics (for example, gain, equalization, etc.) to achieve desired amplification from the operational microphone.

In certain embodiments, the microphone 310 of earworn assembly 102 is operational when the boom/microphone assembly 140 is attached to jack 410 of earworn assembly 1.02 and the two-way communication device is not in use. In such embodiments, the microphone 310 of earworn assembly 102 can detect ambient noise and deliver the ambient noise to the user. In such embodiments, the microphone 310 of earworn assembly 102 is not operational when the two-way communication device is in use (i.e., when being used for two-way communication), for example, when making or receiving a telephone call. In such embodiments, when the two-way communication device is in use, the microphone 610 of the boom/microphone assembly 140 is operational and the microphone 310 of the earworn assembly 102 is not operational. To achieve automatic microphone selection, microprocessor logic can be used to detect whether the two-way communication device is in use, and then select the microphone input accordingly. In such embodiments, the device can automatically adjust amplification characteristics (for example, gain, equalization, etc.) to achieve desired amplification from the operational microphone.

In certain embodiments, the battery 320 (shown in FIG. 3) inside the earworn assembly 102 can be charged using the jack 410 when the boom/microphone assembly 140 is not attached to the jack 410. In such embodiments, a power supply can be connected to the device 100 via jack 410 to charge the battery 320.

In the embodiment shown in FIGS. 1A and 1B, the earworn assembly 102 includes components for receiving and sending electrical signals and communicating sound, a housing 105, an ear tip 135 (shown in FIG. 1B), switch buttons 110, 120, 125, and an earhook retainer 132 (shown in FIG. 1B). The earworn assembly 102 can be worn on a user's right or left ear.

The housing 105 comprises a top cover 106 and a bottom cover 107 (shown in FIG. 1B) and contains electrical components for receiving and sending radio frequency signals and communicating sound. The bottom cover 107 includes a light 115 (shown in FIG. 1B) that can indicate when the device 100 is in use. In certain embodiments, the light 115, and/or other lights, can indicate battery status or provide other status information.

In certain embodiments, components for receiving radio frequency signals and communicating sound to a user can include: a radio frequency module 350 (shown in FIG. 3), a printed circuit board 330 (shown in FIG. 3), a receiver/transducer 340 (shown in FIG. 3), a sound port 103, a damper (not shown), and the ear tip 135. The radio frequency module 350 can receive signals from a device (not shown), for example, a cellular telephone, laptop computer, etc., that is configured to send electrical signals wirelessly to communicate sound. In certain embodiments, for example, the wireless signals can be communicated using the Bluetooth radio frequency communication standard. The radio frequency module 350 can demodulate the received radio frequency signal into an electrical signal that can be passed via the printed circuit board 330 to the receiver/transducer 340. The receiver/transducer 340 can convert the electrical signal into sound. Sound can be passed through sound port 103, a damper, and ear tip 135 and into the ear canal of a user.

In certain embodiments, components for communicating sound received by a microphone include: a microphone (i.e., earworn assembly microphone 310 or boom/microphone assembly microphone 610), a printed circuit board 330, and a radio frequency module 350. The microphone can receive sound from a user and convert the sound into electrical signals. The electrical signals can be passed via the printed circuit board 330 to the radio frequency module 350. The radio frequency module 350 can transmit signals to a device. (not shown), for example, a cellular telephone, laptop computer, etc., that is configured to receive electrical signals wirelessly to communicate sound. In certain embodiments, for example, the wireless signals can be communicated using the Bluetooth radio frequency communication standard.

In the embodiment shown in FIGS. 1A and 1B, the ear tip 135 comprises a plurality of flanges and a through-hole. In certain embodiments, the ear tip can include two, three, four or more flanges. In certain embodiments, the ear tip can comprise a flangeless shape, such as a cylinder, for example, and a through-hole. The ear tip 135 can be made of resilient material. In certain embodiments, the ear tip 135 can be secured to the housing 105 by sliding ear tip 135 over sound port 103 such that sound port 103 enters the through-hole of ear tip 135. In such embodiments, ear tip 135 can be secured to sound port 103 using a protrusion on the sound port 103 that matingly engages a recess in the through-hole of the ear tip 135. The ear tip 135 can be removably attached to the housing 105. This can allow for removal and/or replacement of the ear tip 135. The ear tip 135 can be inserted into the ear canal of a user to thereby substantially acoustically seal the ear canal from external noise and provide support for the device 100. In certain embodiments, the ear canal can provide sole support for the device 100 when the ear tip 135 is inserted therein. The ear tip 135 can be rotatably inserted into the ear canal of a user to provide a snug fit and to position the device 100 in a desired position relative to the mouth of a user. In certain embodiments, the ear tip 135 can provide a reduction of external acoustic noise of at least 15 dB when inserted into the ear canal. In certain embodiments, the ear tip 135 can provide a reduction of external acoustic noise of at least 30 dB when inserted into the ear canal. In certain embodiments, the ear tip can take other forms and can provide the same acoustic sealing and support functions as described above.

In certain embodiments, for example, an ear tip can be configured such that, upon insertion into the ear canal at a first orientation, the ear tip provides a reduction of external acoustic noise of at least 15 dB, and upon insertion into the ear canal at a second orientation, the ear tip provides a reduction of external acoustic noise of less than 15 dB. In certain embodiments, for example, rotation of an ear tip in the ear canal can allow the orientation of the ear tip to be varied, thereby varying the amount of ambient noise leakage to the ear canal.

In the embodiment shown in FIGS. 1A and 1B, the earhook retainer 132 is disposed on the housing and is configured to receive an earhook 130. In certain embodiments, the ear hook 130 can be used to provide additional support for the device 100. The earhook 130 can be removably attached to the housing using the earhook retainer 132. The earhook 130 can be flexibly deformed to conform to the contours of the ear of a user. For example, the ear hook 130 can wrap around the outer ear of a user and can be flexibly deformed to conform to the contours of the ear of a user.

In the embodiment shown in FIGS. 1A and 1B, the switch buttons 110, 120, 125 are coupled to switches disposed within the housing 105. The switch buttons 110, 120, 125 can be used to initiate a multiplicity of functions defined by switch decoding logic that considers the number of switch closures, closure duration and operational context. For example, in certain embodiments, the switch buttons 110, 120, 125 can be used to initiate pairing between Bluetooth-capable devices (for example, a Bluetooth-capable handset and a Bluetooth-capable hands-free headset), call answer, call end, call send, call hold, transfer to handset, and/or call redial.

In certain embodiments, the second switch button 120 can be used to increase the volume of sound communicated to the ear tip 135, and the third switch button 130 can be used to decrease the volume of sound communicated to the ear tip 135. Such embodiments can employ two separate momentary contact switches arranged and decoded such that the desired volume control is available.

In certain embodiments, the switch buttons 110, 120, 125 call be used to mute sound communicated to the ear tip 135. For example, in certain embodiments, depressing the first switch button 110 for a predetermined amount of time, such as three seconds, for example, can mute sound communicated to the ear tip 135. For example, in certain embodiments, depressing both the second and third switch buttons 120, 125 for a predetermined amount of time, such as three seconds, for example, can mute sound communicated to the ear tip 135.

In certain embodiments, the switch buttons 110, 120, 125 can be used to provide a push-to-talk mode of operation. For example, in certain embodiments, sound from a user will not be communicated via the microphone (i.e., the earworn assembly microphone 310 or the boom/microphone assembly microphone 610) unless the first switch button 100 is depressed.

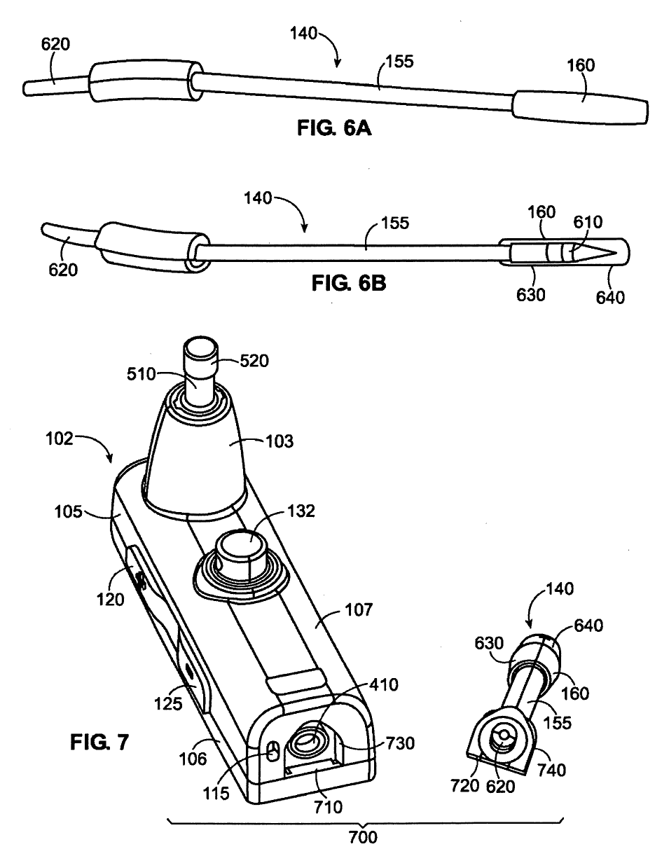

In the embodiment shown in FIGS. 1A and 1B, the boom/microphone assembly 140 includes a connector 620 (shown in FIGS. 6A and 6B) a boom 155, a microphone 610 and a microphone cover 160. The connector 620 is configured to be received by the jack 410 of the earworn assembly 102 and is located at a first end of the boom/microphone assembly 140. In certain embodiments, the connector can comprise a multi-segmented male/female plug arrangement. In certain embodiments, such as the one shown in FIG. 7, for example, the connector is keyed such that the boom/microphone assembly 140 can only be attached to the jack 410 of the earworn assembly 102 in a specific orientation.

In the embodiment shown in FIGS. 1A and 1B, the boom 155 extends from the connector 620. In certain embodiments, the boom can be a flexible boom that is deformable to allow adjustment of the distance between the microphone and the mouth of the user. In certain embodiments, the boom can be a non-flexible boom.

In the embodiment shown in FIGS. 1A and 1B, a microphone 610 is disposed at the end of the boom 155 and is covered by the microphone cover 160. The microphone cover 160 is disposed at a second end of the boom/microphone assembly 140. In certain embodiments, the microphone of the boom/microphone assembly 140 can be a directional microphone (i.e., noise canceling) or an omni-directional microphone. In certain embodiments, the directional microphone can reject at least 20 dB of ambient noise. In certain embodiments, the directional microphone can reject at least 25 dB of ambient noise. In certain embodiments, the microphone can be adjusted relative to the mouth of a user to provide desired rejection of ambient noise.

FIG. 2 illustrates a perspective view of a two-way voice communication device 200 used in accordance with an embodiment of the present technology. The device 200 is shown without the optional earhook. 130 that is shown in FIGS. 1A and 1B.

FIG. 3 illustrates a partially sectioned side view of a two-way voice communication device 300 used in accordance with an embodiment of the present technology. The housing 105 of the device 300 is partially sectioned to show components disposed within the housing 105. The components include a microphone 310, a battery 320, a printed circuit board 330, a receiver/transducer 340 and a radio frequency module 350. The function of the components is described in connection with FIGS. 1A and 1B. In certain embodiments, the microphone 310 of the earworn assembly 102 can be a directional (i.e., noise canceling) microphone or an omni-directional microphone. In certain embodiments, the directional microphone can reject at least 20 dB of ambient noise. In certain embodiments, the directional microphone can reject at least 25 dB of ambient noise.

FIG. 4 illustrates a perspective view of the earworn assembly 102 used in accordance with an embodiment of the present technology. The earworn assembly 102 is shown without the boom/microphone assembly 140 shown in FIGS. 1A and 1B. As discussed above, earworn assembly 102 can be used without the boom/microphone assembly 140. In such embodiments the microphone 310 (shown in FIG. 3) in the earworn assembly 102 can receive speech from a user of the earworn assembly 102. As shown, the earworn assembly 102 includes jack 410. The jack 410 can be used to receive the boom/microphone assembly 140. The jack 410 can also be used to charge the battery 320 (shown in FIG. 3) disposed within the housing 105.

FIG. 5 illustrates a side view of a two-way voice communication device 500 with an earworn assembly 102 without a housing and an ear tip used in accordance with an embodiment of the present technology. The earworn assembly is shown without housing 105 and ear tip 135 to show components that are disposed within the housing 105 or covered by the ear tip 135. For example, portions of the sound port 103, including sound tube 510 and protrusion 520, which are covered when the ear tip 135 is slid over an end of sound port 103, are shown. Components shown in FIG. 5 that are usually disposed in the housing 105, are also shown and described in connection with FIG. 3.

FIG. 6A illustrates a perspective view of a boom/microphone assembly used in accordance with an embodiment of the present technology. The connector 620, which is configured to be received by the jack 410 of the earworn assembly 102, is shown.

FIG. 6B illustrates a partially sectioned perspective view of a boom/microphone assembly 140 used in accordance with an embodiment of the present technology. In FIG. 6B, the microphone cover 160 is partially sectioned to show the microphone 610. In the embodiment shown in FIG. 6B, the microphone cover includes two components, first housing 630 and second housing 640. The microphone 610 is mounted within the microphone cover 160 at the mating line of the first housing 630 and second housing 640.

FIG. 7 illustrates a perspective view of a two-way voice communication device 700 used in accordance with an embodiment of the present technology. In FIG. 7, the boom/microphone assembly 140 is detached from the earworn assembly 102. The boom/microphone assembly 140 can be attached to the earworn assembly 102 by inserting connector 620 into jack 410. Connector 620 and jack 410 are keyed such that connector 620 can only be inserted into jack 410 in one orientation. That is, the portion of housing 105 that surrounds jack 410 has a flat side 710 and a curved side 730. Likewise, the portion of the boom/microphone assembly 140 from which the connector 620 extends has a flat side 720 and a curved side 740. In this embodiment, for example, in order to insert connector 620 into jack 410, the flat sides 710, 720 and the curved sides 730, 740 must be aligned. In certain embodiments, for example, the jack and connector can be keyed using other configurations or other means. In certain embodiments, for example, the jack and connector are not keyed, and can be attached in any orientation.

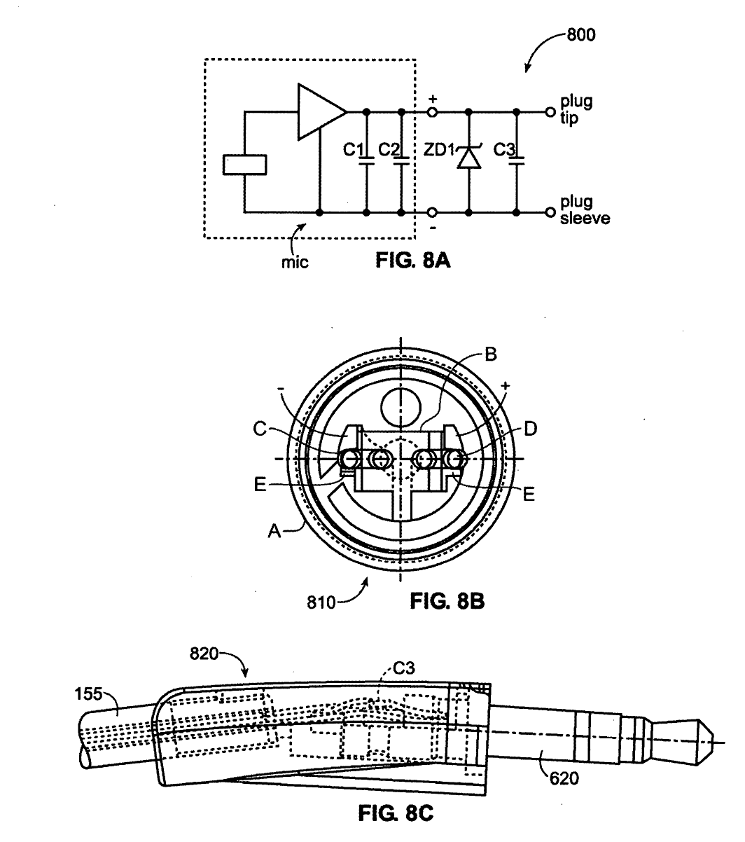

FIG. 8A illustrates a schematic 800 of components used to provide electromagnetic compatibility protection for a two-way communication device used in accordance with an embodiment of the present technology. The schematic 800 includes filtering capacitors C1 and C2 that can be used in a microphone to provide protection against radio frequency interference. The schematic 800 also includes a zener diode ZD1 that can provide protection against high-voltage transients. In certain embodiments, for example, zener diode ZD1 can be mounted in the rear of a microphone. In certain embodiments, for example, back-to-back diode or other semiconductor arrangements can be used to provide protection against high-voltage transients. In certain embodiments, for example, other electrostatic discharge devices can be used to provide protection against high-voltage transients. In certain embodiments, microphone 610 and/or microphone 310 can include some or all of the components illustrated in schematic 800 to provide electromagnetic compatibility protection.

FIG. 8B illustrates a cross-section 810 of components used to provide electromagnetic compatibility protection for a two-way communication device used in accordance with an embodiment of the present technology. Cross-section 810 includes microphone A, zener diode B, gold litz wire C, red litz wire D, and solder E. In certain embodiments, for example, microphone A can be microphone 610 and/or microphone 310. In certain embodiments, for example, zener diode B can be a SOD-523 zener diode. In certain embodiments, for example, solder E can be RoHS compliant solder.

FIG. 8C illustrates a partial side-view of a boom/microphone assembly 820 that includes an ultrasonic interference protection device 820 used in accordance with an embodiment of the present technology. Boom/microphone assembly 820 includes capacitor C3 that can provide ultrasonic interference protection. In the embodiment shown, capacitor C3 is disposed between boom 155 and connector 620. In certain embodiments, for example, a capacitor that provides ultrasonic interference protection can be disposed elsewhere in a boom/microphone assembly.

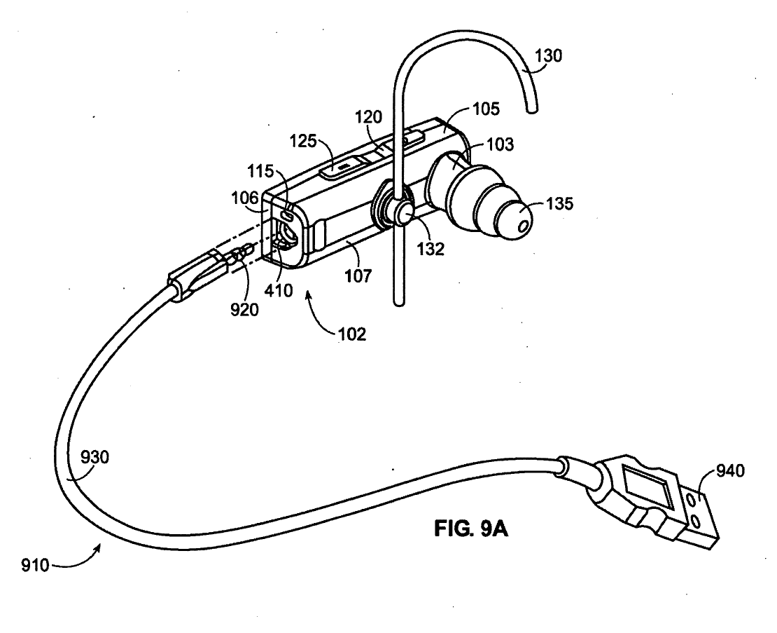

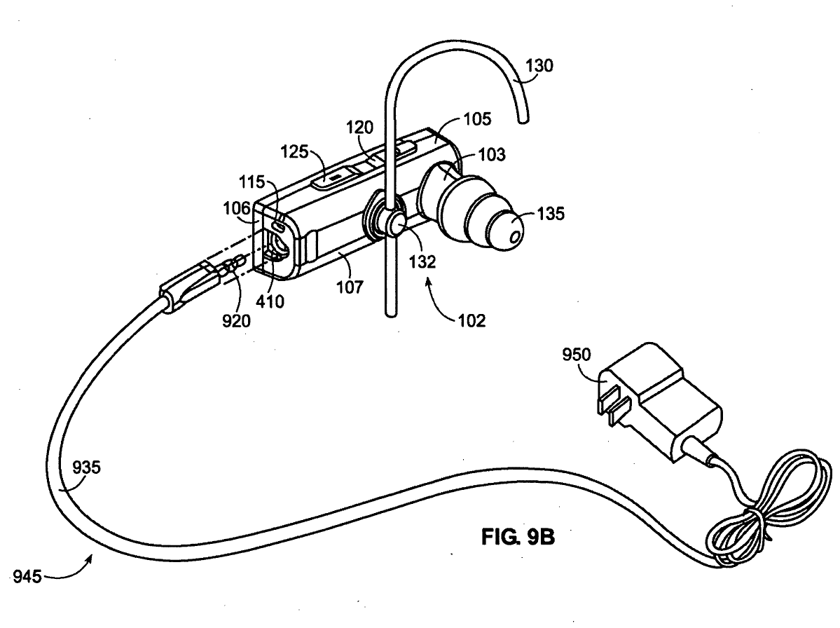

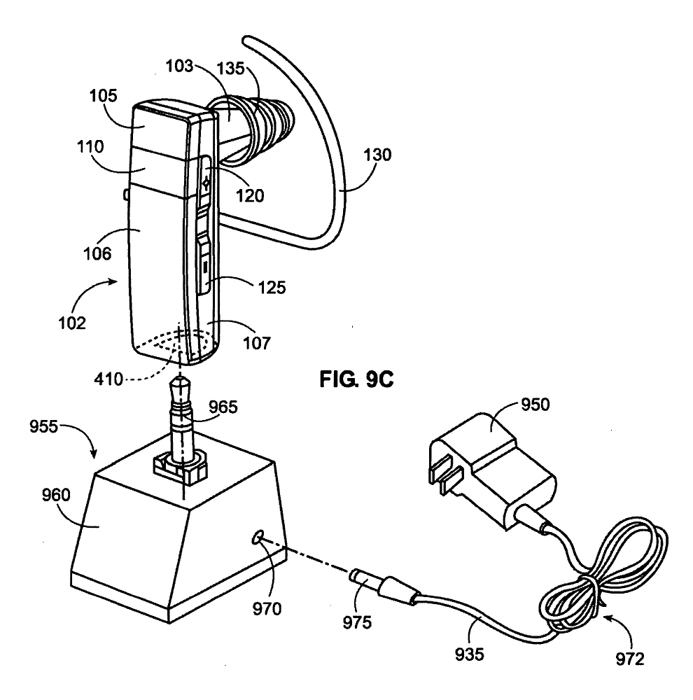

FIG. 9A illustrates a battery charging connection 910 and an earworn assembly 102 used in accordance with an embodiment of the present technology. Battery charging connection 910 includes connector 920, wire 930 and universal serial bus connector 940. Battery charging connection 910 can be attached to the earworn assembly 102 by inserting connector 920 into jack 410. Battery charging connection 910 can be attached to a power source by plugging universal serial bus connector 940 into a universal serial bus port (not shown). Power can be supplied from the power source to a battery 320 (shown in FIG. 3) inside the earworn assembly 102 via the battery charging connection 910.

In the embodiment shown in. FIG. 9A, connector 920 and jack 410 are keyed such that connector 920 can only be inserted into jack 410 in one orientation. In certain embodiments, for example, the jack and connector can be keyed using other configurations or other means. In certain embodiments, for example, jack and connector are not keyed, and can be attached in any orientation.

FIG. 9B illustrates a battery charging connection 945 and an earworn assembly 102 used in accordance with an embodiment of the present technology. Battery charging connection 945 includes connector 920, wire 935 and alternating current connector 950. Battery charging connection 945 can be attached to the earworn assembly 102 by inserting connector 920 into jack 410. Battery charging connection 945 can be attached to a power source by plugging alternating current connector 950 into an outlet that provides alternating current. Power can be supplied from the power source to a battery 320 (shown in FIG. 3) inside the earworn assembly 102 via the battery charging connection 945.

In the embodiment shown in FIG. 9B, connector 920 and jack 410 are keyed such that connector 920 can only be inserted into jack 410 in one orientation. In certain embodiments, for example, the jack and connector can be keyed using other configurations or other means. In certain embodiments, for example, jack and connector are not keyed, and can be attached in any orientation.

FIG. 9C illustrates a battery charging connection 955 and an earworn assembly 102 used in accordance with an embodiment of the present technology. Battery charging connection 955 includes cradle 960 and adapter 972. Cradle 960 includes connector 965 and port 970. Cradle 960 can be attached to the earworn assembly 102 by inserting connector 965 into jack 410. Adapter 972 includes plug 975, wire 935 and alternating current connector 950. Adapter 972 can be attached to cradle 960 by plugging plug 975 into port 970. Cradle 960 can be attached to a power source by plugging alternating current connector 950 into an outlet that provides alternating current. Power can be supplied from the power source to a battery 320 (shown in FIG. 3) inside the earworn assembly 102 via the battery charging connection 955.

In the embodiment shown in FIG. 9C, connector 965 and jack 410 are keyed such that connector 965 can only be inserted into jack 410 in one orientation. In certain embodiments, for example, the jack and connector can be keyed using other configurations or other means. In certain embodiments, for example, jack and connector are not keyed, and can be attached in any orientation.

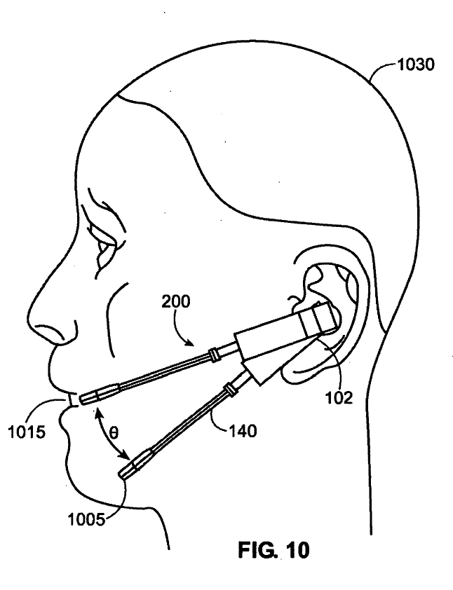

FIG. 10 illustrates a two-way voice communication device 200 used in accordance with an embodiment of the present technology that is positioned on the head of a user 1030. The device 200 includes an earworn assembly 102 and a boom/microphone assembly 140. In certain embodiments, the earworn assembly can be used without the boom/microphone assembly 140. In such embodiments, the microphone in the earworn assembly 102 is operational. In FIG. 10, the device 200 is being worn on the left ear of the user 1030. The device 200 can also be worn on the right ear of a user. The device 200 can be rotated in the ear canal of user 1030 through the angle 0 such that the end of the boom/microphone assembly 1005 is positioned in a desired position relative to the mouth of user 1030.

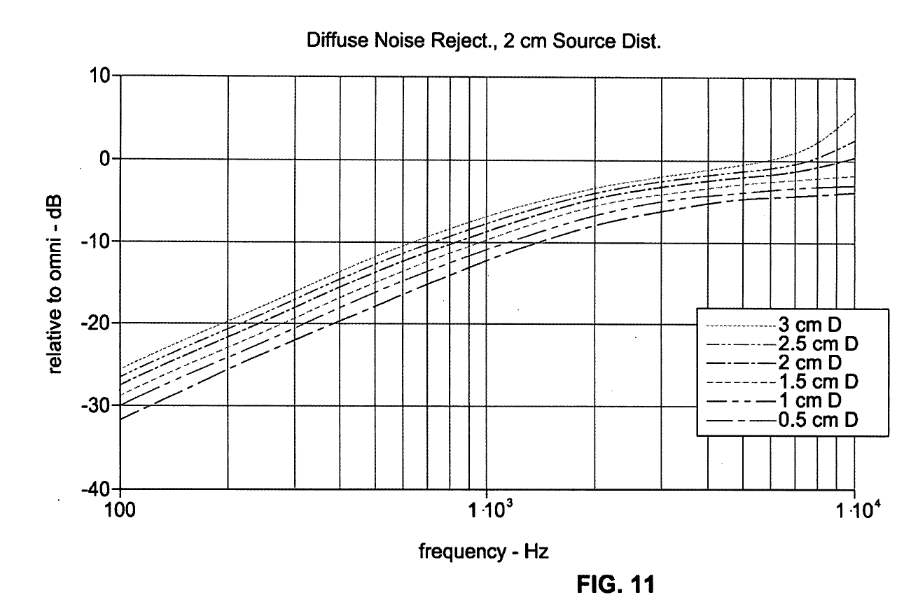

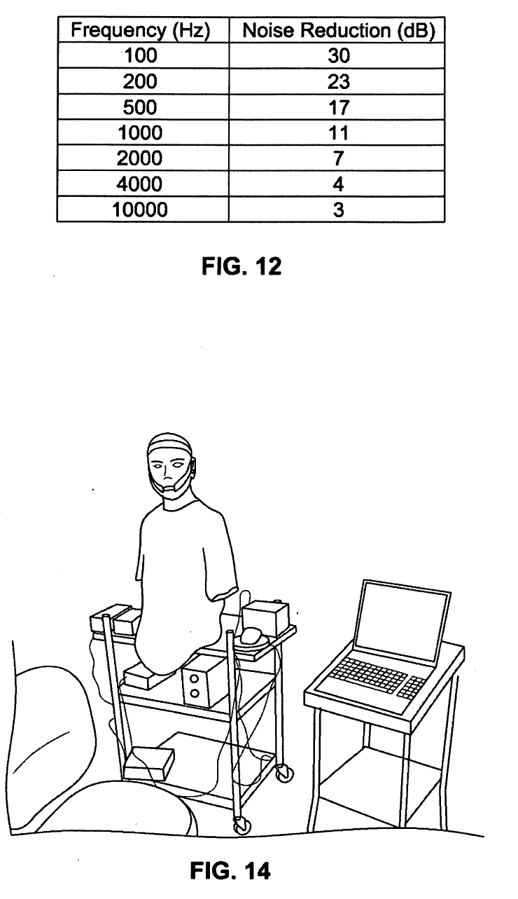

FIG. 11 illustrates estimated noise reduction in dB of a directional microphone disposed on a boom/microphone assembly relative to noise reduction of a microphone mounted with an earworn assembly (referred to as “omni” microphone in the graph) as a function of frequency in Hz. Each of the six lines represents a directional microphone of a specific port spacing diameter. The top line corresponds to a directional microphone with a port spacing diameter of 3 cm. The second line corresponds to a directional microphone with a port spacing diameter of 2.5 cm. The third line corresponds to a directional microphone with a port spacing diameter of 2 cm. The fourth line corresponds to a directional microphone with a port spacing diameter of 1.5 cm. The fifth line corresponds to a directional microphone with a port spacing diameter of 1.0 cm. The bottom line corresponds to a directional microphone with a port spacing diameter of 0.5 cm. According to FIG. 11, in certain embodiments, a directional microphone disposed on a boom/microphone assembly with a port spacing diameter of 1.0 cm can provide noise reduction as shown, for example, in FIG. 12.

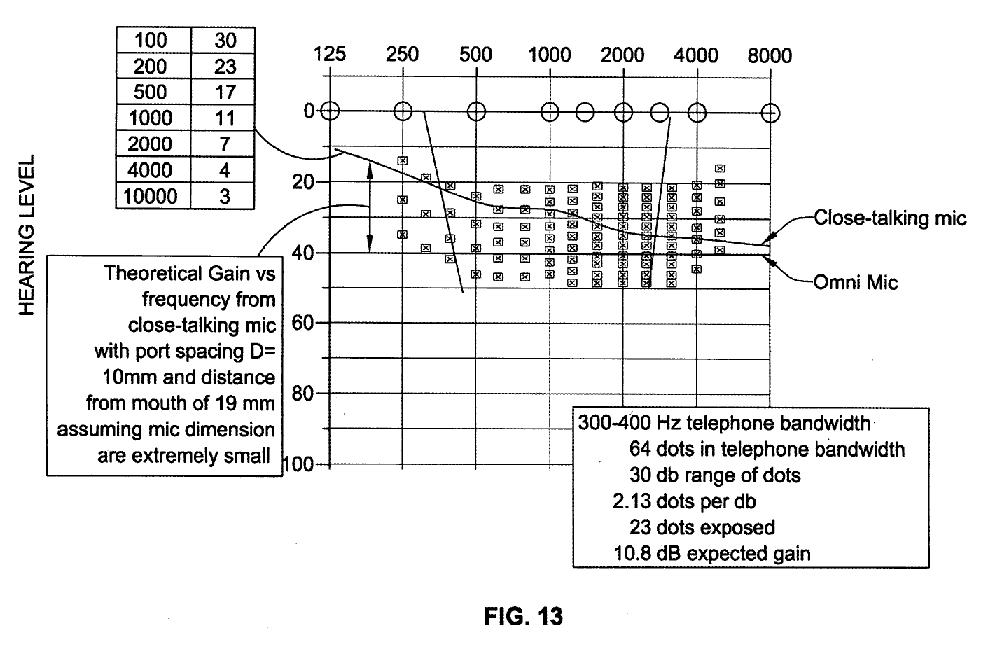

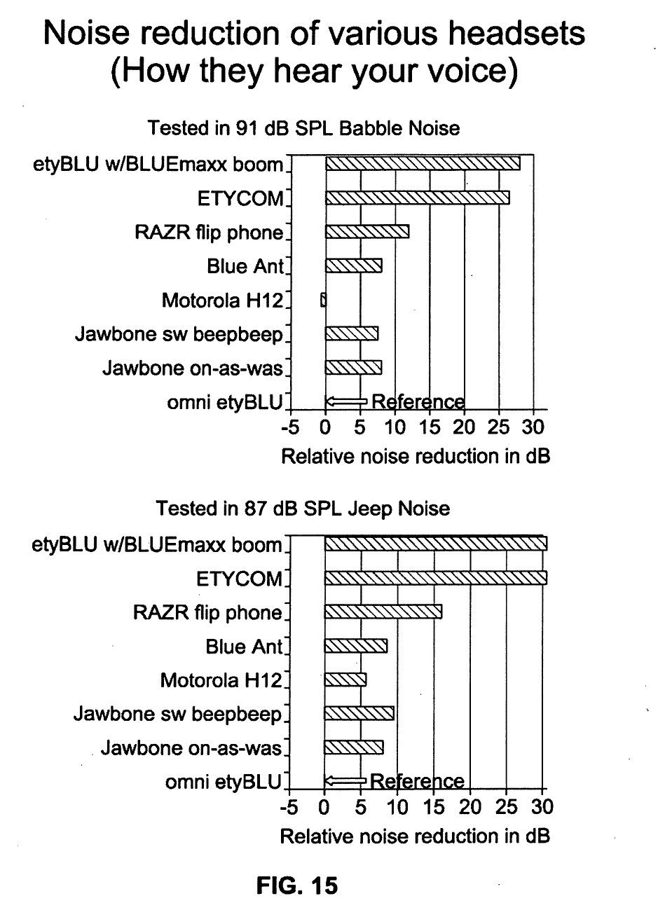

FIG. 13 illustrates an estimated equivalent frequency-independent noise reduction (SNR gain) for speech, estimated from the Count-The-Dot Articulation Index. As shown in FIG. 13, the 300-4000 Hz telephone bandwidth includes: 64 of 100 original “speech cue” dots; a 30 db range of speech cues; 2.13 dots per db; 23 dots exposed by frequency-dependent noise rejection of a noise-cancelling microphone with 1 cm port spacing and 20 mm (2 cm) distance to mouth; 10.8 dB expected gain. Certain devices, sometimes referred to as omni-mics, for example, exhibit a 98 mm distance between a microphone mounted with the earworn assembly and the mouth. Certain devices, sometimes referred to as close-talking mics, for example, exhibit a 15 mm distance between a microphone disposed on a boom/microphone assembly and the mouth. Certain devices exhibit SNR gain (effective noise reduction) from being close to the mouth of about 14.2 dB gain. The value of 14 dB is close to the improvement of 12 dB and 16 dB, demonstrated by the RAZR flip phone in experiments (see, e.g., FIG. 15). The RAZR design places its omni-directional microphone about 19 mm from the mouth, compared to the typical 98 mm distance. Total predicted effective noise reduction (SNR gain) from directional microphone disposed on a boom/microphone assembly relative to noise reduction of a microphone mounted with an earworn assembly or a typical Bluetooth mono headset is about 25.0 dB.

As with the boom design disclosed in United States Patent Application Publication No. 2004/0165720, entitled “Two-Way Voice Communication Device Having External Acoustic Noise Reduction”, published Aug. 26, 2004, which is incorporated herein by reference in its entirety, we have measured an advantage of 5 db or more from the particular shape of the boom microphone tip and the location of the holes with the “front” hole close to the mouth and the “rear” hole with the “rear” hole on the side of the eartip back and opposite the mouth. The location of the directional microphone holes is discussed, in the following references, which are incorporated herein by reference in their entirety: U.S. Provisional Patent Application Ser. No. 60/507,629, entitled “Noise Canceling Microphone With Acoustically Tuned Ports”, filed Sep. 30, 2003; and U.S. Pat. No. 7,162,041, entitled “Noise Canceling Microphone With Acoustically Tuned Ports”, issued Jan. 9, 2007.

In certain embodiments of the present technology, expected total noise reduction taking into account tip design is about 30.0 dB in a diffuse noise field (typical, for example, of cars, restaurants, etc.).

Several commercially available Bluetooth and wired headsets were tested in the Etymotic Research reverberation room with two different noise sources (babble and Jeep SUV noise) on the “BLUMAR” manikin (see FIGS. 14-18). The BLUMAR™ manikin has appropriate mouth opening and its internal loudspeaker has been digitally equalized to insure real-life voice spectra). The BLUMAR™ manikin is illustrated in FIG. 14.

For the tests, the output of a RAZR cellphone hooked to an Etymotic Research ETYCOM headset sealed into an equalized 2cc coupler as receiver was recorder. The transmitter was another RAZR cellphone, connected to one of the Bluetooth headsets under test or, in as one reference condition, used directly. Each headset was located on the BLUMAR manikin, taking care to position the microphone the normal position from the mouth opening. The BLUMAR “talker” produced peaks of 72 dB at one meter, 98 dB at 19 mm from the mouth opening, and 83 dB at a position 100 mm from the mouth opening where the omni-directional microphone of a typical Bluetooth headset is located.

The noise level was increased in 5 dB steps from 66 dB to 91 dB for the multitalker babble and from 62 dB to 87 dB SPL for the recorded jeep noise. The constant-level talker sentences were reproduced from the female talker in the Etymotic Research QuickSIN test CD. By increasing the noise in this way, a point is reached at which the noise dominates the talker and some or all of the words in the corresponding sentence are missed. When the noise rejection of the headset or cellphone was great enough, it was necessary to reduce the talker level by 10 dB or 20 dB before the highest noise level would dominate the talker. This happened with the RAZR flip phone, whose microphone is located close to the mouth, and with the boom mounted microphone disclosed herein. Reducing the talker level corresponds naturally to the real-world condition when a talker does not wish to be overheard. Indeed, the ability of the headset disclosed herein (with a boom-mounted microphone) to allow user voice levels that are nearly inaudible to surrounding persons is one of its principal advantages, preventing the common problem of inadvertantly broadcasting details of the talkers romance life, latest big sale, or credit card numbers to a group of people.

After the recordings were made as described for each headset, they were monitored on playback to see how many of the five key words in each sentence could be heard accurately. From this information, the equivalent noise SPL at which 50% of the words in sentences could be identified correctly was determined.

The results, which are depicted in FIG. 15, showed a significantly greater noise reduction for the new design than produced by existing designs. As a check, live-voice recordings were made with a speaker monitoring a Sound Level Meter fed from a boom microphone close to the user's mouth. The noise levels were increased in 5 dB steps as before.

In FIG. 15, a prototype of a two-way communication device with boom-mounted microphone as disclosed herein is referred to as etyBLU with BLUmaxx boom. In the table above, the ETYCOM is a wired headset made by Etymotic, Inc.

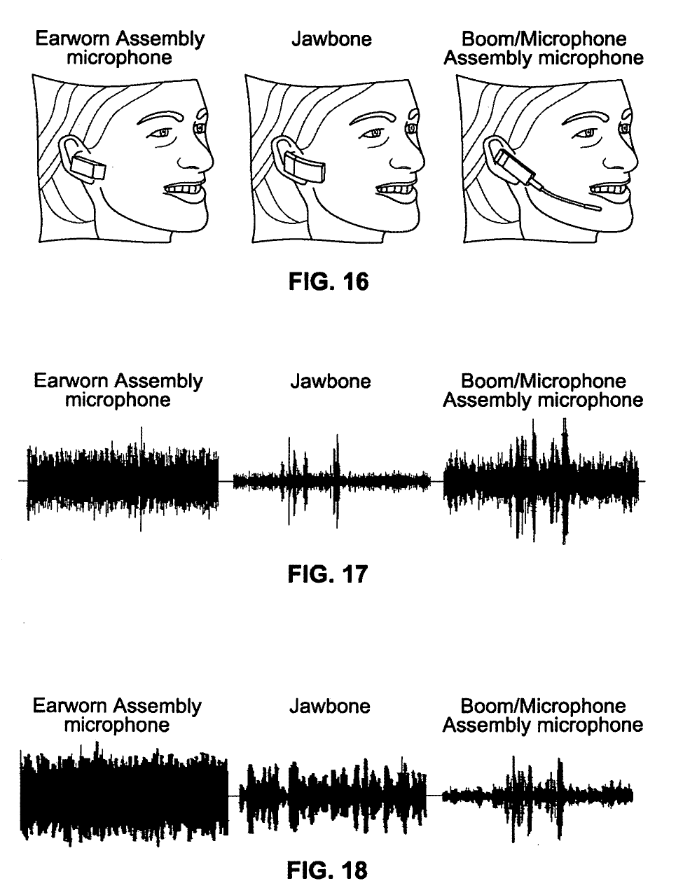

Further, a test comparing intelligibility of words spoken into the microphone of the earworn assembly, a jawbone device and the microphone of the boom/microphone assembly was conducted in 87 dB SPL jeep noise and 91 dB SPL babble noise. FIG. 16 depicts the devices. The results in 87 dB SPL jeep noise (a constant hum, for example, from being in an automobile) are shown in FIG. 17. On the far left of FIG. 17 are the results for the earworn assembly microphone. The sound is all background noise and the spoken words cannot be heard. In the middle of FIG. 17 are the results for the jawbone device. The device eliminated the background noise, but portions of the spoken words were also eliminated, and the words were not intelligible. On the right of FIG. 17 are results for the boom/microphone assembly microphone. Some background noise can still be heard, and the words come through clearly.

The results in 91 dB SPL babble noise (a cacophony of speech, for example, from being in a crowded area where many people are speaking at once) are shown in FIG. 18. On the far left of FIG. 18 are the results for the earworn assembly microphone. The spoken words are not decipherable from the background noise. In the middle of FIG. 18 are the results for the jawbone device. The background noise is reduced, but the spoken words are not decipherable from the background noise. On the right of FIG. 18 are results for the boom/microphone assembly microphone. Some background noise can still be heard, and the words come through clearly.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A two-way communication device comprising:
a housing;
a receiver mounted with the housing for transducing a first electrical signal into sound;
an ear tip for insertion into an ear canal of a user, wherein sound from the receiver is delivered through the ear tip to the user;
a first microphone for transducing speech of the user into a second electrical signal, wherein the first microphone is disposed on a boom that is detachably connected to the housing; and
a second microphone for transducing speech of the user into a third electrical signal, wherein the second microphone is mounted with the housing,
wherein when the boom is attached to the housing, the first microphone is operational and the second microphone is not operational, and when the boom is not attached to the housing, the second microphone is operational and the first microphone is not operational.

2. The two-way communication device of claim 1, wherein the first microphone is a directional microphone.

3. The two-way communication device of claim 2, wherein the first microphone rejects at least 20 dB of ambient noise.

4. The two-way communication device of claim 1, wherein a portion of the boom that attaches to the housing is keyed such that the boom can only be attached to the housing in one orientation.

5. The two-way communication device of claim 1, wherein the second microphone is an omni-directional microphone.

6. The two-way communication device of claim 1, further comprising:
a battery mounted with the housing; and
a charging jack mounted with the housing, wherein the battery receives power from the charging jack, and wherein the charging jack is only accessible when the boom is not attached to the housing.

7. The two-way communication device of claim 1, wherein upon insertion into the ear canal, the ear tip secures the device in an operable position on the head of the user without requiring use of additional attachment to the user.

8. The two-way communication device of claim 1., wherein upon insertion of the ear tip into the ear canal, the ear canal provides sole support of the device.

9. The two-way communication device of claim 1, wherein upon insertion into the ear canal, the ear tip provides a reduction of external acoustic noise of at least 15 dB.

10. The two-way communication device of claim 1, wherein upon insertion into the ear canal, the ear tip provides a reduction of external acoustic noise of at least 30 dB.

11. The two-way communication device of claim 1, wherein the boom is a flexible boom that is deformable to allow adjustment of the distance between the microphone and the mouth of the user.

12. The two-way communication device of claim 1, further comprising a switch for canceling the electrical signal from the first microphone or the second microphone.

13. The two-way communication device of claim 1, further comprising a switch supporting at least one of the following operations: pairing, call answer, call end, call send, call hold, transfer to handset, and call redial.

14. The two-way communication device of claim 1, further comprising a switch that allows the user to control the volume of sound communicated through the ear tip.

15. The two-way communication device of claim 1, further comprising:
a radio frequency receiver for demodulating a first radio frequency signal into the first electrical signal; and
a radio frequency transmitter for transmitting a second radio frequency signal, wherein the second radio frequency signal is modulated to carry the second electrical signal or the third electrical signal.

16. The two-way communication device of claim 16, wherein the radio frequency communication is compliant with the Bluetooth radio frequency communication standard.

17. The two-way communication device of claim 1, wherein the ear tip is removably attached to the housing.

18. The two-way communication device of claim 1, wherein the ear tip is rotatable within the ear canal of the user to permit adjustment of the vertical position of the housing.

19. The two-way communication device of claim 1, wherein the ear tip is made of resilient material and comprises a plurality of flanges that, upon insertion into the ear canal, compress, thereby securing the device within the ear canal.

20. The two-way communication device of claim 1, further comprising an ear hook configured to be removably attached to the housing, wherein the ear hook is configured to contact the back of the ear, thereby providing further support of the device when the ear tip is inserted into the ear canal.

21. A two-way communication device comprising:
a housing;
a receiver mounted with the housing for transducing a first electrical signal into sound;
an ear tip for insertion into an ear canal of a user, wherein sound from the receiver is delivered through the ear tip to the user;
a first microphone for transducing speech of the user into a second electrical signal, wherein the first microphone is disposed on a boom that is detachably connected to the housing;
a battery mounted with the housing; and
a charging jack mounted with the housing,
wherein the battery receives power from the charging jack, and wherein the charging jack is only accessible when the boom is not attached to the housing.

22. The two-way communication device of claim 21, further comprising a second microphone for transducing speech of the user into a third electrical signal,
wherein the second microphone is mounted with the housing, and
wherein when the boom is attached to the housing, the first microphone is operational and the second microphone is not operational, and when the boom is not attached to the housing, the second microphone is operational and the first microphone is not operational.

23. The two-way communication device of claim 21, wherein the first microphone is a directional microphone.

24. The two-way communication device of claim 21, wherein a portion of the boom that attaches to the housing is keyed such that the boom can only be attached to the housing in one orientation.

25. The two-way communication device of claim 22, wherein the second microphone is an omni-directional microphone.

26. A two-way communication device comprising:
a housing;
a receiver mounted with the housing for transducing a first electrical signal into sound;
an ear tip for insertion into an ear canal of a user, wherein sound from the receiver is delivered through the ear tip to the user;
a first microphone for transducing speech of the user into a second electrical signal, wherein the first microphone is disposed on a boom that is detachably connected to the housing; and
a second microphone for transducing speech of the user into a third electrical signal, wherein the second microphone is mounted with the housing,
wherein when the device is in use, the first microphone is operational and the second microphone is not operational, and when the device is not in use, the first microphone is not operational and the second microphone is operational to provide ambient noise to the ear canal of the user.

27. A device comprising:
a housing;
a receiver mounted with the housing for transducing a first electrical signal into sound; and
an ear tip for insertion into an ear canal of a user, wherein sound from the receiver is delivered through the ear tip to the user, wherein upon insertion into the ear canal at a first orientation, the ear tip provides a reduction of external acoustic noise of at least 15 dB, and wherein upon insertion into the ear canal at a second orientation, the ear tip provides a reduction of external acoustic noise of less than 15 dB.
